(19) United States
(12) Patent Application Publication
(10) Pub. No.: US 2011/0153584 A1
(43) Pub. Date: Jun. 23, 2011

(54) METHOD, SYSTEM, AND ENGINE DISPATCH FOR CONTENT SEARCH

(75) Inventors: Zhanming Wei, Beijing (CN); Xiao Li, Beijing (CN)

(73) Assignee: HANGZHOU H3C TECHNOLOGIES CO., LTD., Hangzhou City (CN)

(21) Appl. No.: 12/808,342

(22) PCT Filed: Jun. 3, 2008
(86) PCT No.: PCT/CN2008/071169

§ 371 Date: Jun. 15, 2010

(30) Foreign Application Priority Data
Dec. 29, 2007 (CN) 200710308529.X

(51) Int. Cl. G06F 17/30; G06F 12/08

(52) U.S. Cl. 707/706; 707/E17.108

(57) ABSTRACT

The present invention discloses a method, system, and engine dispatch unit for content search, wherein the engine dispatch unit connects to at least a processor and two search engines, obtains objects from the processor(s), and selects search engines to perform content search according to the load of each search engine; the selected search engines perform content search for the objects according to preset matching rules. Solutions of the present invention can effectively improve content search performance.

### TECHNICAL FIELD

This invention relates in general to search technologies and more particular to a method, system, and engine dispatch unit for content search.

### BACKGROUND OF THE INVENTION

Currently, content search is widely applied to network security and information search. Particularly for the network layer and application layer technologies, content search efficiency is a key performance measurement index.

FIG. 1 is a schematic diagram of existing content search systems. As shown in FIG. 1, a simple content search system comprises: a processor, a cache, and a search engine. The processor and cache comprises a processing unit. The process of a content search is: the processor saves the object to be searched such as an Internet Protocol (IP) packet in the cache, and notifies the search engine to start searching; upon receiving the notification, the search engine performs Direct Memory Access (DMA) to obtain the searched object from the cache through the channel that connects to the processor, matches the object with the Aho-Corasick (AC) string matching algorithm or regular expression based matching algorithm according to a preset matching rule, and saves the search result in the cache, indicating whether a matched result is found; the processor reads the search result from the cache.

In existing content search systems, one processing unit matches one search engine, and the search engine that has fixed search ability uses a serial mode to perform content search. When the processor in the processing unit saves multiple objects to be searched in the cache, the corresponding search engine performs a search for the object at the top of the cache, and thus the objects at lower positions are queued for search. As is apparent, the existing content search systems have low search speed and performance when performing multiple tasks at the same time.

In addition, the matching rule of a content search determines the search depth. For example, one rule matches one character a in IP packets, and another rule matches the number of the character a contained in IP packets. Obviously, the former has a less search depth than the latter, and thus less time is required. However, if the matching rule for an object at the top of the cache is much more complicated than that for the objects at the lower positions, the latter must wait until the search process of the former is complete. As a result, the search becomes very slow and search performance is low.

Furthermore, with one processor corresponding to one search engine, the operation of each search engine is independent of each other. When a search engine has many tasks to process, other search engines do not help it share the load even though they are idle. The uneven task allocation results in low search speed and resource waste.

### SUMMARY OF THE INVENTION

The present invention provides a content search method to improve content search performance.

In the method, wherein,

an engine dispatch unit obtains an object to be searched from a processor and selects a search engine for performing the search according to the load of each search engine; the selected search engine performs a content search for the object according to the preset matching rule.

The present invention also provides a content search system to improve content search performance.

The content search system comprises at least one processor, an engine dispatch unit, and at least two search engines. Wherein, the processor sends an object to be searched; the engine dispatch unit obtains the object from the processor and selects a search engine for the object according to the load of each search engine; the selected search engine receives the object from the engine dispatch unit and performs a content search for the object according to the preset matching rule.

The present invention also provides an engine dispatch unit to improve content search performance.

The engine dispatch unit comprises: a front-end processing module and a back-end processing module. The former obtains an object to be searched from a processor and outputs the object; the latter selects a search engine for the object according to the load of each search engine, and sends the object to the selected search engine.

In the solution above, the engine dispatch unit in the present invention connects to at least one processor and two search engines, and selects the search engine for performing the content search according to the load of each search engine. When multiple objects are to be searched, the engine dispatch unit can allocate the objects to multiple search engines, so that the queuing time for objects to be searched is reduced and the content search speed and performance are improved.

In addition, because a search engine is selected for an object to be searched according to the load of the search engine, the search engine that has lower load is selected for performing a complicated search. Therefore, the waiting time of objects to be searched at the back position is reduced, and the search performance is improved.

All the search engines in the present invention are controlled and dispatched by the engine dispatch unit, and thus multiple processors can share all search engines. The engine dispatch unit can allocate multiple objects sent from one processor on different search engines, thus avoiding uneven task allocation. As a result, the load among search engines is balanced, search speed is improved, fewer resources are wasted, and device utilization is improved.

### BRIEF DESCRIPTION OF THE DRAWINGS

FIG. 1 is the block diagram of an existing content search system.

FIG. 2 is a flow chart illustrating a method for content search in the present invention.

FIG. 3 is a block diagram illustrating a content search system in the present invention.

FIG. 4 is the block diagram of a content search system in embodiment 1 of the present invention.

FIG. 5 is a flow chart illustrating a method of initializing the system for content search in embodiment 1 of the present invention.

FIG. 6 is a flow chart illustrating a content search method in embodiment 1 of the present invention.

FIG. 7 is the block diagram of the content search system in embodiment 2 of the present invention.

FIG. 8 is the block diagram of a content search system in embodiment 3 of the present invention.

FIG. 9 is a flow chart illustrating a content search method in embodiment 4 of the present invention.

### DETAILED DESCRIPTION OF THE INVENTION

For a better understanding of the present invention, and to show more clearly how it may be carried into effect, reference will now be made, by way of example, to the accompanying drawings which aid in understanding embodiments of the present invention.

The engine dispatch unit in the present invention connects to at least one processor and two search engines in advance. Thus, the engine dispatch unit can control and dispatch the processors and search engines.

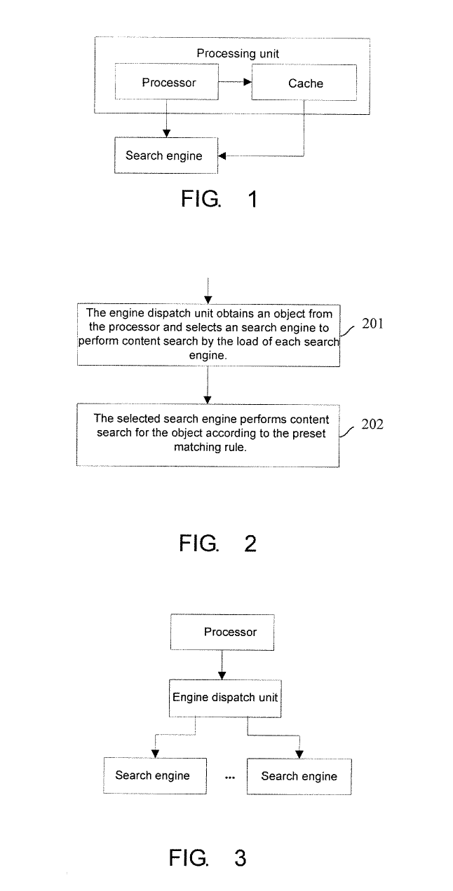

FIG. 2 shows a flow chart illustrating a content search method in the present invention. As shown in FIG. 2, a content search of the present invention comprises the following steps:

At step 201, the engine dispatch unit obtains an object from a processor, and selects a search engine for performing the search according to the load of each search engine;

At step 202, the search engine performs a content search for this object according to the preset matching rule.

FIG. 3 shows a block diagram illustrating a content search system in the present invention. As shown in FIG. 3, the system comprises at least one processor, an engine dispatch unit, and at least two search engines. Wherein, the processor sends an object to be searched to the engine dispatch unit; the engine dispatch unit obtains the object from the processor and selects a search engine for the object according to the load of each search engine; the selected search engine receives the object from the engine dispatch unit and performs a content search for the object according to the preset matching rule.

As shown above, the engine dispatch unit in the present invention connects to at least one processor and two search engines, and selects the search engine for performing the content search according to the load of each search engine. When multiple objects are to be searched, the engine dispatch unit can allocate the objects to multiple search engines, so that the queuing time for objects to be searched is reduced and the content search speed and performance are improved. In addition, because a search engine is selected for an object to be searched according to the load of the search engine, the search engine that has lower load is selected for performing a complicated search. Therefore, the waiting time of objects to be searched at the back position is reduced, and the search performance is improved.

All the search engines in the present invention are controlled and dispatched by the engine dispatch unit, and thus multiple processors can share all the search engines. The engine dispatch unit can allocate multiple objects sent from one processor on different search engines, thus avoiding uneven task allocation. As a result, the load among search engines is balanced, search speed is improved, fewer resources are wasted, and device utilization is improved.

The engine dispatch unit comprises a front-end processing module and a back-end processing module. The former obtains an object from a processors; and the latter selects a search engine to perform content search for the object obtained from the front-end processing module, and send it to the selected search engine.

In addition, the present invention can further comprise a first cache for caching objects in the engine dispatch unit, or a second cache that directly connects to the processors in the content search system, or both the first and second caches. In practice, the first and second caches can be First In First Out (FIFO) memories. The objects to be searched in the present invention can be network layer packets or application layer packets.

The following takes IP packets for example to explain content search solutions in the present invention in details.

### Embodiment 1

The interface that connects a processor to the engine dispatch unit, and connects a search engine to the engine dispatch unit can be a Peripheral Component Interconnect express (PCIe) interface, Serial Peripheral Interface 4.0 (SPI4) interface, or HyperTransport Bus (HTB) interface. The number of search engines attached to the engine dispatch unit depends on the system throughput.

If the engine dispatch unit connects to two or more processors, a management interface need be selected in advance for transmitting configuration and control information between the engine dispatch unit and each processor. Either of the following modes is used to select a management interface in this embodiment:

1. Default mode: An interface with a specific interface number or priority can be used as the default management interface. For example, the interface numbered 0, or the interface that works normally and has the highest priority. The priority of each interface between each processor and the engine dispatch unit can be preset.

2. Election mode: Upon system startup, each processor performs a handshake with the engine dispatch unit, and the interface of the processor that first performed the handshake successfully is elected as the management interface. When a management interface operates abnormally, another handshake is triggered, and the interface that first performs the handshake successfully is elected as the new management interface. In this mode, the management flag bit is set for each interface. The management flag bit of the interface selected as the management interface is set to 1, whereas that of other interfaces is set to 0; or the management flag bit of the management interface is set to 0, whereas that of other interfaces is set to 1.

With a management interface selected, the processor where the management interface resides becomes an administration unit that obtains the operation status and other information of the engine dispatch unit through that management interface.

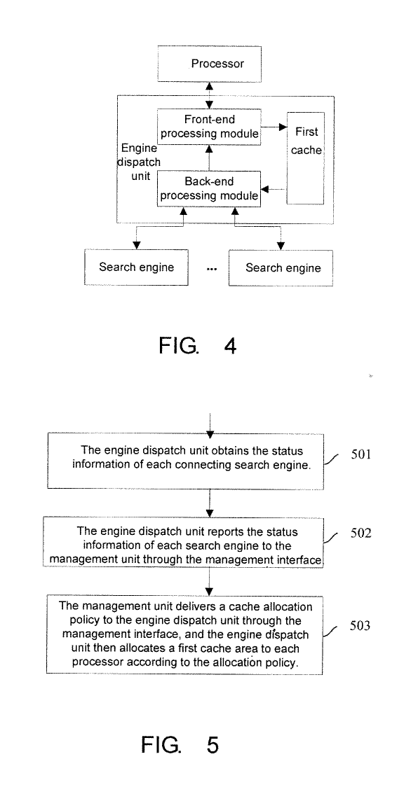

FIG. 4 is a block diagram of the content search system in this embodiment. As shown in FIG. 4, the engine dispatch unit in FIG. 3 further comprises: a front-end processing module, a back-end processing module, and a first cache. The two modules communicate with the processor and each search engine respectively.

To ensure normal operation of the content search system in embodiment 1, initialize the system before performing a content search. FIG. 5 is a flow chart illustrating a method of initializing the content search system in embodiment 1. As shown in FIG. 5, the flow chart comprises the following steps:

At step 501, the engine dispatch unit obtains the status information of each connecting search engine.

At this step, the back-end processing module in the engine dispatch unit scans each interface that connects to the search engines to obtain the status information of each connecting search engine and the number of connecting search engines that work normally. The status information also includes the load information of each search engine.

At step 502, the engine dispatch unit reports the status information of each search engine to the management unit through the management interface.

At step 503, the management unit delivers a cache allocation policy to the engine dispatch unit through the management interface, and the engine dispatch unit then allocates a first cache area to each processor according to the allocation policy.

The allocation policy can be static or dynamic. Static allocation policies comprise the equal allocation mode and processing capability based allocation mode. Dynamic allocation policies comprise the modes based on the processor load, cache load, and processor service type. If a static allocation policy is used, the engine dispatch unit allocates the first cache only when the system is powered on. If a dynamic allocation policy is used, the engine dispatch unit allocates the first cache when the system is powered on, and dynamically adjusts the first cache allocation during the system operation.

In the static equal allocation mode, the font-end processing module in the engine dispatch unit obtains the number of processors that connect to the unit, then divides the total size of the first cache by that number to obtain the first cache size, start address, and end address of every processor, and advertises them to the corresponding processor.

In the static processing capability based allocation mode of static allocation policy, the front-end processing module in the engine dispatch unit obtains the processing capability of each processor, then allocates the first cache size, start address, and end address to each processor according to the processing capability, and advertises them to the corresponding processor. Specifically, the front-end processing module allocates a larger first cache area to the processor of stronger processing capability. For example, the first cache area allocated to the processor with a core speed of 500 MHz may be half the size of that allocated to the processor with a core speed of 1 GHz.

In the dynamic allocation mode based on the processor load, the front-end processing module in the engine dispatch unit obtains the load of each processor, assigns the first cache size, start address, and end address for every processor, and advertises them to the corresponding processor. Specifically, at the system startup, the front-end processing module in the engine dispatch unit allocates an initial first cache size to each processor according to the load of each processor, and determines start and end addresses of each processor. Generally, the front-end processing module allocates a smaller initial first cache area to a processor with heavier load (high CPU utilization). During system operation, the front-end processing module keeps obtaining the load of each processor. When the load of a processor reaches the preset upper threshold, the module reduces the first cache size for the processor, and re-determines the start and end addresses of the processor; when the load of a processor is less than the preset lower threshold, the module increases the first cache size for the processor, and re-determines the start and end addresses of that processor. For example, when a CPU utilization is more than 90%, the front-end module reduces the first cache size of the processor to half of the initial size; when a CPU utilization is less than 70%, the module restores the first cache size to the initial size. Many methods are provided to obtain the load of each processing unit. For example, every processing unit measures its own load periodically, and delivers the load to the front-end processing module in the engine dispatch unit; or, the front-end processing module notifies every processing unit to measure the load, and then every processing unit delivers the load to the front-end processing module.

In the dynamic allocation mode based on the cache load, at the system startup, the front-end processing module in the engine dispatch unit can use the equal allocation mode or the allocation mode based on processing capability to assign a first cache size, a start address, and an end address to each processor, and advertise them to the corresponding processor; during the operation of the system, the module checks the cache load of each processor. When the cache load of a processor exceeds the preset upper threshold for a preset period of time, the module increases the first cache size and re-determines the start and end addresses of the processor; when the cache load of a processor is less than the preset lower threshold for a preset period of time, the module reduces the first cache size and re-determines the start and end addresses of the processor. For example, when the first cache of a processor is in full load for more than 10 minutes, the front-end processing module increases the first cache size to 150% of the initial size of that processor; when the first cache load of a processor is lower than 50% for 10 minutes, the front-end processing module reduces the first cache size to half of the initial size.

In the dynamic allocation mode based on the processor service type, the front-end processing module in the engine dispatch unit obtains the service type of each processor, assigns the first cache size, start address, and end address for every processor, and advertises them to the corresponding processor. Specifically, the front-end processing module resolves the IP packet header or packet content to obtain the service type. The former is more efficiency than the latter.

After the first cache is allocated, the initialization process in embodiment 1 is complete. However, if the system does not contain caches, the initialization ends after step 501 and 502 are complete.

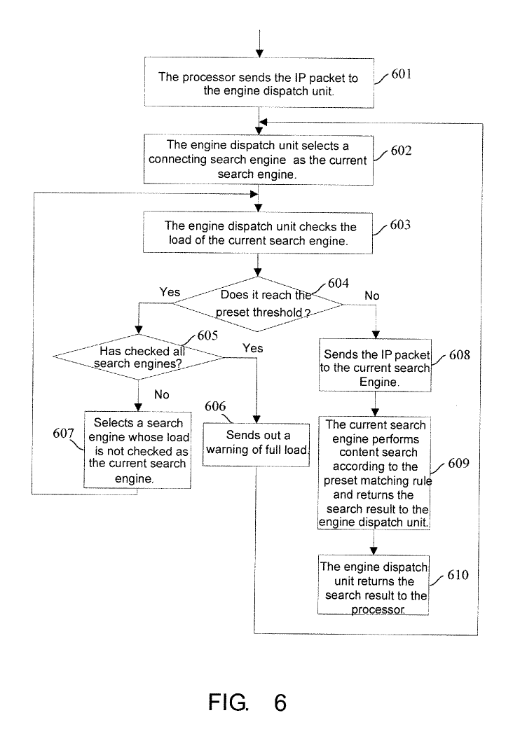

FIG. 6 is a flow chart illustrating a method for content search in embodiment 1 of the present invention. As shown in FIG. 6, an IP packet is used as the object to be searched for example, and the content search comprises the following steps:

At step 601, the processor sends the IP packet to the engine dispatch unit.

At this step, when determining that the IP packet requires a content search, the processor delivers the IP packet as an object to be searched to the front-end processing module in the engine dispatch unit through the interface that connects to the engine dispatch unit. Then, the front-end processing module saves the received IP packet in the first cache of that processor. The back-end processing module uses either of the following methods to read the IP packet from the first cache of a processor. Method 1: The back-end processing module periodically scans the first cache and reads the IP packets in turn, if there is any. Method 2: when saving a received IP packet in the first cache, the front-end processing module notifies the back-end processing module of the object to be searched, and then the back-end processing module directly reads the IP packet from the first caches. In method 2, the front-end processing module can add the priority of each object to the notification, so that the back-end processing module can read the objects from the first cache in the descending order of priority.

At step 602 to step 604, the engine dispatch unit selects a connecting search engine as the current search engine, checks whether the load of the current engine reaches the preset threshold. If yes, the engine dispatch unit proceeds to step 605; if not, it proceeds to step 608.

The back-end processing module in the engine dispatch unit uses the first engine that works normally as the current search engine, or chooses any of the connecting search engines that works normally as the current search engine.

In this embodiment, every search engine contains a third cache whose size is represented by the number of packets the third cache saves. The back-end processing module in the engine dispatch unit can detect the number of IP packets sent to each search engine, the number of processed IP packets, and the size of each third cache, and then calculate the current load of each search engine by using this formula: the current load of a search engine=(the number of IP packets sent to the search engine−the number of IP packets processed by the search engine)/the third cache size of the search engine. The current load is expressed in percentage value.

At step 605 to step 607, the engine dispatch unit decides whether it has checked all the search engines in a traversal. If yes, it sends out a “full load on search engines” warning and returns to step 602; if not, it selects an unchecked search engine in that traversal as the current search engine and then returns to step 603.

All the search engines mentioned in the embodiment can work normally. If the load of every search engine is detected once, a traversal is considered to be complete.

If all search engines have been checked in a traversal, but the last search engine (that is, the current search engine) has a heavy load, the engine dispatch unit decides that all attached search engines cannot perform any other content search. Then the front-end processing module in the engine dispatch unit sends a “full load on search engines” warning to the processor that sends the IP packet at step 601, indicating that no search engine can perform a content search for this IP packet at present.

If an unchecked search engine exists in the traversal, the engine dispatch unit decides that the proper search engine can be found, and then selects a search engine and detects its load.

At step 608 to step 610, the back-end processing module sends the received IP packet to the current search engine, and the current search engine then performs a content search for the IP packet according to the preset matching rule, and returns the search result to the processor that sent the IP packet.

The search engine can use existing methods to perform a content search for the IP packet. After finishing the content search, the search engine returns the search result to the back-end processing module in the engine dispatch unit, then the back-end processing module delivers the search result to the front-end processing module, and the front-end processing module returns the search result to the processor that sends the IP packet at step 601.

Until now, the content search in embodiment 1 is complete.

As is apparent, the content search solution in this embodiment of the present invention can effectively speed up content search, improve search performance, and reduce resource waste. In addition, with only an engine dispatch unit added to the existing system, the content search is easily implemented with low cost. Furthermore, during the system initialization, the engine dispatch unit can use multiple methods to allocate the first cache to processors. This meets the diversified storage requirements of content search, ensures sufficient size for saving objects to be searched, and thus guarantees the normal operation of content search.

Accordingly, in the content search system of this embodiment as shown in FIG. 4, the front-end processing module in the engine dispatch unit receives an object to be searched from a processor, saves it in the first cache corresponding to the processor, receives the search result from the back-end processing module, and returns it to the processor that sends the object. The first cache saves the object sent from the front-end processing module. The back-end processing module reads the object to be searched from the first cache corresponding to the processor that sends the object, selects a search engine to perform the content search according to the load of each search engine. In other words, it selects a search engine with the load less than the preset threshold, sends the object to the search engine, receives the search result from the search engine, and returns the result to the front-end processing module.

In addition, the back-end processing module periodically scans the first cache to read objects of all processors; or, the front-end processing module, after saving the an object to be searched in the first cache, notifies the back-end processing module of the object, and then the back-end processing module reads the objects from the first cache; or, the front-end processing module adds the priority of each object to the notification and sends the notification to the back-end processing module, and the back-end processing module then reads the objects from the first cache in the descending order of priority.

During the initialization of the system, the front-end processing module in the engine dispatch unit in the embodiment of the invention receives the cache allocation policy from the processor acting as the management unit and the status information of each search engine from the back-end processing module, allocate a first cache area to each processor according to the allocation policy and status information, and return each allocated first cache size, start address, and end address to the corresponding processor. The back-end processing module detects the status of each search engine that connects to the engine dispatch unit, and sends the status information to the front-end processing module.

### Embodiment 2

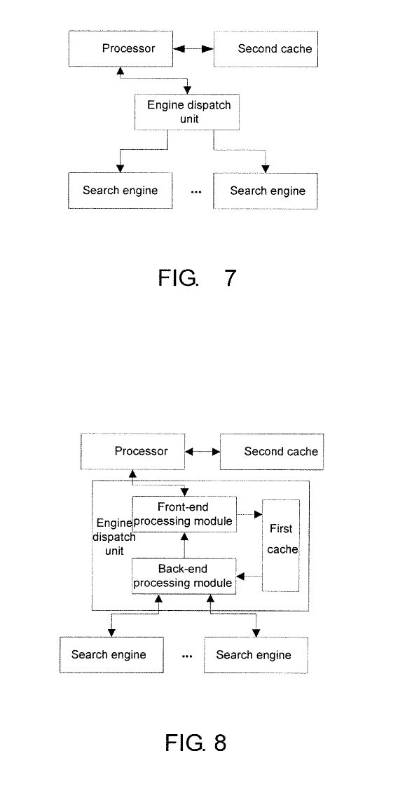

Different from embodiment 1, the engine dispatch unit in embodiment 2 does not have a first cache, but the content search system comprises an independent second cache that directly connects to each processor. FIG. 7 is a block diagram of the content search system in this embodiment. As shown in FIG. 7, the system comprises a processor, a second cache, an engine dispatch unit, and at least two search engines. The processor operates in a similar way as that in embodiment 1, but sends objects to be searched indirectly. The processor saves objects in the second cache, and then the engine dispatch unit obtains the objects from the second cache through the processor. The second cache saves objects received from the processor. The engine dispatch unit obtains objects from the second cache, then selects search engines in the same way as embodiment 1 to perform content searches, and delivers the search results to the processor.

The search engines in embodiment 2 operate the same as in embodiment 1. In the engine dispatch unit, the front-end processing module obtains an object to be searched from the second cache, sends the object to the back-end processing module, receives the search result from the back-processing module, and returns the result to the processor. The back-end processing module receives the object to be searched from the front-end processing module, selects a search engine for content search according to the load of each search engine. In other words, it selects a search engine with the load less than the preset threshold, sends the object to the search engine, receives the search result from the search engine, and returns the result to the front-end processing module.

During the initialization of the content search system, every processor initializes the corresponding second cache area instead of being assigned with a first cache area because the second cache connects to each processor directly. In other words, the back-end processing module obtains the status information of the search engine that the engine dispatch unit connects to, and sends it to the front-end processing module; then the front-end processing module sends the status information to the processor that serves as the management unit.

For the content search procedure, the IP packet serving as an object to be searched in this embodiment is transmitted differently from that in embodiment 1 during the system initialization. Specifically, a processor in this embodiment saves the IP packet in the corresponding area of the second cache, and the engine dispatch unit then obtains the IP packet from the second cache. The engine dispatch unit can obtain the IP packet in multiple ways. For example, the engine dispatch unit periodically scans the second cache for an object to be searched, and reads each found object through the corresponding processor; or a processor saves an object in the second cache and notifies the engine dispatch unit of the object, and then the engine dispatch unit reads the object from the second cache; or the processor adds the priorities of the object in the notification sent to the engine dispatch unit, so the engine dispatch unit obtains the objects from the second cache in the descending order of priority.

Then, the content search system proceeds with step 602 to step 610 in embodiment 1.

### Embodiment 3

Embodiment 3 combines embodiment 1 with embodiment 2, and the content search system in this embodiment comprises both first and second caches.

FIG. 8 shows the block diagram of the content search system in this embodiment. As shown in FIG. 8, the system comprises a processor, a second cache, an engine dispatch unit, and at least two search engines. The engine dispatch unit comprises: a front-end processing module, a first cache, and a back-end processing module.

The initialization process in this embodiment follows the identical steps as those in embodiment 1.

As for the content search process, a processor first save an object to be searched in the second cache, and then the engine dispatch unit obtains the object (for example, an IP packet) from the second cache. The engine dispatch unit can obtain the object in the same way as that in embodiment 2. Then similar as at step 601 in embodiment 1, the front-end processing module in the engine dispatch unit saves the received IP packet in the corresponding area of the first cache, and the back-end processing module obtains the IP packet from the first cache. The back-end processing module can obtain the object in the same way as that in embodiment 1. Then, the content search system proceeds with step 602 to step 610 in embodiment 1.

The search engines in the above three embodiments can perform content search based on characters and regular expressions.

### Embodiment 4

In this embodiment, search engines are classified according to the types of matching rules. For example, the search engines can be classified into character search engines or regular expression search engines. A character search engine performs content searches based on characters only. The search tasks are simple and thus such content searches are performed faster. A regular expression search engines performs content searches based on both characters and regular expressions. When selecting a search engine to perform a content search, the engine dispatch unit in this embodiment first checks the load of each character search engine. If no character search engine can perform a content search, a proper regular expression search engine is selected.

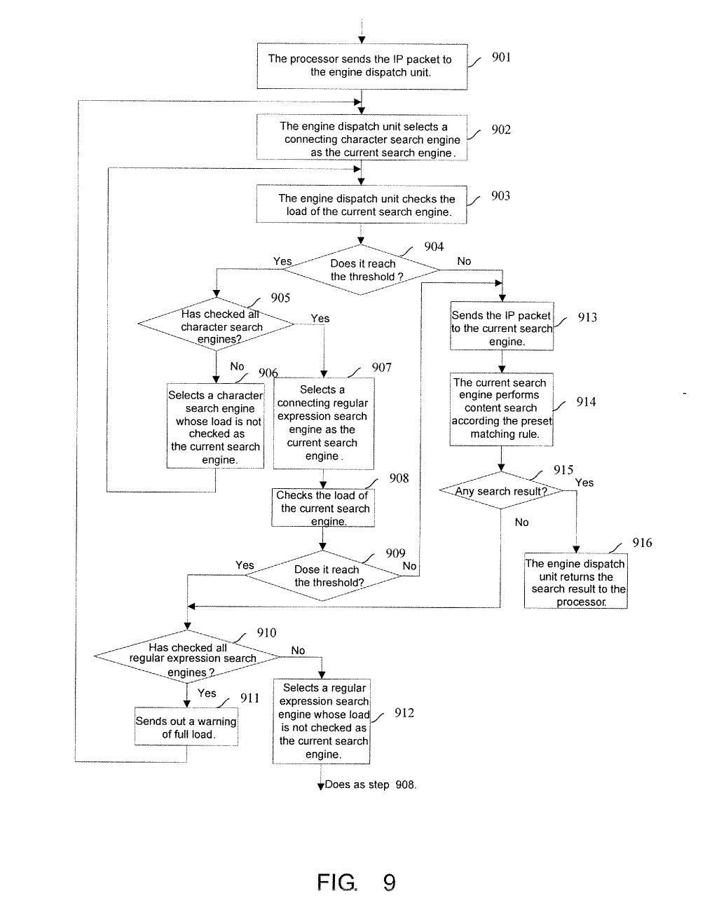

FIG. 9 is a flow chart illustrating a content search method in embodiment 4 of the present invention. As shown in FIG. 9, this method comprises the following steps:

At step 901, the processor sends an IP packet to the engine dispatch unit, wherein,

the processor, as acting in embodiment 1, sends the IP packet to the corresponding area in the first cache, and then the back-end processing module in the engine dispatch unit reads the IP packet from the first cache; or as acting in embodiment 2, the processor saves the IP packet in the connecting second cache, and the front-end processing module reads the IP packet from the second cache and then delivers the packet to the back-end processing module; or as acting in embodiment 3, the processor saves the IP packet in the connecting second cache, then the front-end processing module in the engine dispatch unit reads the IP packet from the second cache and saves the packet in the corresponding area of the first cache, and the back-end processing module reads the IP packet from the first cache.

At step 902, the engine dispatch unit selects a connecting character search engine as the current search engine.

In this embodiment, upon obtaining an IP packet, the engine dispatch unit cannot decide the type of matching rules to be used to perform a content search for the IP packet. Because a character search engine is efficient and fast in performing content search, the engine dispatch unit selects a character search engine and determines whether this search engine can perform a content search for the IP packet by subsequent steps.

At step 903 and step 904, the engine dispatch unit checks whether the load of the current search engine reaches the preset threshold. If yes, it proceeds to step 905; if not, it proceeds to step 913.

At step 905 to step 907, the engine dispatch unit checks whether it has checked all the character search engines in the traversal; if yes, it selects a connecting regular expression search engine as the current search engine; if not, it selects a character search engine whose load is not checked and returns to step 903.

When the load of the current search engine reaches the threshold, the search engine is unable to perform content search any more; when all character search engines are of heavy load, the engine dispatch unit preferably selects a regular expression search engine.

At step 908 and step 909, the engine dispatch unit checks whether the load of the current search engine reaches the threshold. If yes, it proceeds to step 910; if not, it proceeds to 913.

The load threshold of a regular expression search engine can be the same as or different from that of a character search engine. If they are different, the threshold at step 904 can be called as the threshold of the character search engine and the threshold at this step can be called as the threshold of the regular expression search engine.

If the load of the current regular expression search engine can support a content search for the IP packet at step 901, the content search starts at step 913.

At step 910 and step 911, the engine dispatch unit checks whether it has checked the load of all regular expression search engines. If yes, it sends out a “full load on search engines” warning, and returns to step 902; if not, it proceeds to step 912.

At step 912, the engine dispatch unit selects a regular expression search engine with unchecked load as the current search engine, and returns to step 908.

If no search engine with suitable load is found and regular expression search engines with unchecked load still exists, the engine dispatch unit continues to select a search engine to perform content search.

The back-end processing module in the engine dispatch unit performs all the steps from 902 to 912.

At step 913 and step 914, the engine dispatch unit sends the received IP packet to the current search engine, and the current search engine performs a content search for the IP packet according to the preset matching rule.

After a character or regular expression search engine with a suitable load is selected for content search, the back-end processing module in the engine dispatch unit delivers the IP packet to the search engine.

At step 915 and step 916, the engine dispatch unit checks whether it receives the search result from the search engine. If yes, it returns the result to the processor that sends the IP packet and completes the content search; if not, it returns to step 910.

Unable to perform content search based on regular expressions, a character search engine does not return any search result to the processor if it cannot perform content search for the received IP packet. Thus, a regular expression instead of character search engine is selected. In addition, if the current regular expression search engine fails to return any search result, another regular expression search engine is selected.

A threshold of the waiting time for the search result can be preset. The timing starts when the IP packet is sent to the current search engine at step 913. If no search result is received from the current search engine when the waiting time exceeds the threshold, the engine dispatch unit determines that no search result is received.

Until now, the content search process in embodiment 4 is complete.

In embodiment 4, search engines are classified into character and regular expression search engines according to the type of matching rules. A character search engine with proper load is first selected. If the load of all character search engines cannot meet the requirement of a content search, a regular expression search engine is selected. The classification of search engines reduces the scope for selecting search engines, thus saving the selection time and enhancing the efficiency for performing content search.

Embodiment 4 can use the content search system as shown in FIG. 4, FIG. 7, or FIG. 8. In the content search system, all components except the back-end processing module are the same as embodiments 1, 2, and 3. The back-end processing module in this embodiment receives an object to be searched, classifies the search engines connecting to the engine dispatch unit into character search engines and regular expression search engines, selects a character search engine or regular expression search engine whose load is lower than the preset threshold to perform a content search, and then sends the object to the selected search engine. The back-end processing module returns the search result, if any, to the front-end processing module; if no search result is received, the back-end processing module re-selects a regular expression search engine whose load is lower than the preset threshold, and returns to send the object to the selected search engine.

As mentioned in embodiments 1, 2, 3, and 4 above, the present invention uses an engine dispatch unit to connect at least one processor and two search engines. The processor(s) and search engines comprise a search engine array that flexibly performs content search, reduces the search time, and enhances search efficiency. The engine dispatch unit schedules the search engines to fully use resources and avoid unbalanced load of search engines. In addition, the present invention can flexibly expand or reduce search engines. In other words, newly attached search engines only need be connected to the engine dispatch unit, and the search engines to be reduced only need be disconnected from the ports of the engine dispatch unit. The operation is simple to perform and has good scalability, thus improving the processing capability of the content search system.

Although embodiments of the invention and advantages are described in detail, a person skilled in the art could make various alternations, additions, and omissions without departing from the spirit and scope of the present invention as defined by the appended claims.

1. A content search method, wherein an engine dispatch unit connecting at least one processor and two search engines is preset, comprising:
the engine dispatch unit obtaining an object from the processor, and selecting a search engine to perform a content search according to the load of each search engine;
the search engine performing a content search for this object according to a preset matching rule.

2. The method of claim 1, wherein selecting the search engine according to the load comprises:
the engine dispatch unit selecting a search engine whose load is lower than the preset threshold to perform content search.

3. The method of claim 2, wherein the engine dispatch unit selects a search engine whose load is lower than the preset threshold to perform content search, comprising:
the engine dispatch unit selecting a connecting search engine as the current search engine and checking its load;
determining whether the load reaches the preset threshold, if yes, selecting a search engine whose load is not checked in the traversal and returning to check its load; if not, using the current search engine to perform content search.

4. The method of claim 3, wherein before selecting a search engine whose load is not checked in the traversal, the engine dispatch unit performs the following:
checking whether all search engines are checked in the traversal, if yes, sending out a warning about full load on the search engines; if not, selecting a search engine whose load is not checked in the traversal.

5. The method of claim 2, wherein,
the search engine can be a character search engine or a regular expression search engine;
the engine dispatch unit selecting a search engine whose load is lower than the preset threshold as the current search engine comprises:
selecting a character search engine preferably or a regular expression search engine, with the load of either engine less than the preset threshold to perform content search.

6. The method of claim 5, wherein selecting a character search engine preferably or a regular expression search engine, with the load of either engine less than the preset threshold to perform content search, comprises the following steps:
At step B11, the engine dispatch unit selects a connecting character search engine as the current search engine and checks the load of the search engine;
At step B12, the engine dispatch unit checks whether the load of the current search engine reaches the preset threshold of the character engine, if yes, performs step B13; if not, uses the current search engine to perform a content search according to a preset matching rule;
At step B13, the engine dispatch unit checks whether all character search engines are checked in the traversal, if yes, selects a connecting regular expression search engine as the current search engine, checks its load, and performing step B14; if not, selects a character search engine whose load is not checked in the traversal and returns to check the load as described at step B11; and
At step B14, the engine dispatch unit checks whether the load of the current search engine reaches the preset threshold of the regular expression search engine; if yes, selects a regular expression search engine whose load is not checked and returning to check the load as described at step B13; if not, uses the current search engine to perform a content search for the object according to the preset matching rule.

7. The method of claim 6, wherein before selecting a regular expression search engine whose load is not checked in the traversal at step B14, the engine dispatch unit further performs the following:
checking whether all regular expression search engines are checked in the traversal, if yes, returning to step B11; if not, selecting a regular expression search engine whose load is not checked.

8. The method of claim 7, wherein after selecting a search engine to perform content search according to the preset matching rule, the engine dispatch unit further performs the following:
checking whether all regular expression search engines are checked in the traversal before receiving any search result from the search engine that is selected to perform content search.

9. The method of claim 1, wherein after selecting a search engine to perform content search according to the preset matching rule, the engine dispatch unit further performs the following:
receiving the search result from the search engine and returning it to the processor that sends the object.

10. The method of claim 1, wherein before the engine dispatch unit obtaining an object to be searched from the processor, the engine dispatch unit further performs the following:
initializing the processor, engine dispatch unit, and search engines.

11. The method of claim 10, wherein,
the engine dispatch unit obtains the status information of the connecting search engines, and reports the information to the processor that serves as the management unit through the preset management interface.

12. The method of claim 11, wherein,
the engine dispatch unit further comprises a first cache;
after reporting the information to the processor that serves as the management unit, the engine dispatch unit further comprises: allocating an area of the first cache to each processor according to the preset cache allocation policy.

13. The method of claim 12, wherein the engine dispatch unit allocates an area of the first cache to each processor according to the preset cache allocation policy, comprising:
the engine dispatch unit determining the number of processors it connects to, dividing the total size of the first cache by this number, and calculating the first cache area, start address, and end address of each processor, and advertising them to the corresponding processor; or,
the engine dispatch unit obtaining the processing capability of each processor, then allocating a first cache area, start address, and end address to each processor according to the processing capability, and advertising them to the corresponding processor.

14. The method of claim 3, wherein after advertising to processors, the engine dispatch unit further performs the following:
checking the first cache load of each processor; when the cache load of a processor has exceeded the preset upper threshold for a preset time interval, increasing the first cache size and re-determining the start and end addresses of the processor; when the cache load of a processor has been less than the preset lower threshold for a preset time interval, reducing the first cache size and re-determining the start and end addresses of the processor; and
advertising the new first cache size, start address, and end address to the corresponding processor.

15. The method of claim 12, wherein the engine dispatch unit allocates a first cache area to each processor according to the preset cache allocation policy, comprising:
the engine dispatch unit obtaining the load of each processor, allocating an initial first cache area to each processor according to the load, determining the start and end addresses, and advertising them to each processor; and
the engine dispatch unit checking the load of each running processor; when the load of a processor reaches the preset upper threshold, the engine dispatch unit reducing the first cache size, and re-determining the start and end addresses of the processor; when the load of a processor is less than the preset lower threshold, the engine dispatch unit increasing the first cache size, and re-determining the start and end addresses of that processor; then the engine dispatch unit advertising the new first cache size, start address, and end address to the processor.

16. The method of claim 12, wherein the engine dispatch unit allocates a first cache area to each processor according to the preset cache allocation policy, comprising:
the engine dispatch unit obtaining the service type of each processor, allocating a first cache size, start address, and end address to each processor, and advertising them to the corresponding processor.

17. An engine dispatch unit comprising a front-end processing module and a back-end processing module, wherein,
the front-end processing module obtains objects from processors;
the back-end processing module selects search engines to perform content search according to the load of each search engine, and sends the received objects to the selected search engine.

18. The engine dispatch unit of claim 17, wherein,
a first cache saves objects from the front-end processing module; and
the front-end processing module saves an object to the first cache area of the processor that sends the object, notifies the back-end processing module of the object, and the back-end processing module reads the object upon reaching the notification; or
the front-end processing module saves an object to the first cache area of the processor that sends the object, and then the back-end processing module reads the object by periodically scanning the first cache.

19. The engine dispatch unit of claim 18, wherein,
the back-end processing module further allocates a first cache area to each processor according to the preset cache allocation policy, and sends the first cache size, start address, and end address of each processor to the front-end processing module;
the front-end processing module further sends the received first cache size, start address, and end address to the corresponding processor.

20. The engine dispatch unit of claim 17, wherein the front-end processing periodically scans the areas of the second cache or receives the notification from a processor, and reads the object from the second cache.

21. The engine dispatch unit of claim 17, wherein,
the back-end processing module obtains the status information of the search engines that connect to the engine dispatch unit, and sends the information to the front-end processing module;
the front-end processing module reports the status information to the processor that serves as the management unit through the preset management interface.

22. The method of claim 17, wherein the back-end processing module selects a search engine from those with the load lower than the preset threshold to perform content search.

23. The engine dispatch unit of claim 22, wherein the back-end processing module selects one of the search engines that connect to the engine dispatch unit as the current search engine, and checks whether the load of the search engine reaches the threshold; if yes, the back-end processing module selects a search engine whose load is not checked in the traversal as the current search engine, and returns to check the load; if not, the back-end processing module determines the current search engine to perform content search.

24. The engine dispatch unit of claim 22, wherein the back-end processing module selects a character search engine preferably or a regular expression search engine, with the load of either engine less than the preset threshold, to perform content search.

25. The engine dispatch unit of claim 17, wherein the back-end processing module sends the search result from the search engine to the front-end processing module; the front-end processing module sends the search result to the processor that sends the object.

26. A content search system, which comprises: at least one processor, one engine dispatch unit, and at least two search engines, wherein,
the processor sends objects to be searched;
the engine dispatch unit obtains objects from the processor, and selects search engines to perform content search according to the load of each search engine;
the search engine receives objects from the engine dispatch unit and performs content search for the objects according to preset matching rules.

27. The content search system of claim 26, wherein the engine dispatch unit comprises: a front-end processing module and a back-end processing module, wherein,
the front-end processing module obtains objects from processors;
the back-end processing module selects search engines to perform content search by the load of each search engine, and send objects to the selected search engine.

28. The content search system of claim 27, wherein the engine dispatch unit further comprises a first cache that saves objects sent from the front-end processing module;
the front-end processing module sends the object to the first cache of the processor that sends the object, notifies the back-end processing module of the object, and the back-end processing module reads the object upon reaching the notification; or
the front-end processing module sends the object to the first cache of the processor that sends the object, and then the back-end processing module reads the object by scanning the first cache.

29. The content search system of claim 26, wherein, the content search system further comprises a second cache that saves objects from the corresponding processor;
a processor saves objects to the corresponding second cache, and informs the engine dispatch unit of the objects. Upon receiving the notifications, the engine dispatch unit obtains the objects from the second cache; or, the processor saves objects in its corresponding second cache, and the engine dispatch unit obtains the objects by periodically scanning the second cache.

30. The content search system of claim 26, wherein,
the search engine returns the search result to the engine dispatch unit;
the engine dispatch unit returns the received search result to the processor that sends the object.
